(19) United States
(12) Patent Application Publication
(10) Pub. No.: US 2025/0310688 A1
(43) Pub. Date: Oct. 2, 2025

(54) AUDIO SIGNAL RESTORATION METHOD AND APPARATUS, DEVICE, STORAGE MEDIUM, AND COMPUTER PROGRAM

(71) Applicant: HUAWEI TECHNOLOGIES CO., LTD., Shenzhen (CN)

(72) Inventors: Yining SHEN, Hangzhou (CN); Bo CHEN, Shenzhen (CN); Tianxiang CAO, Hangzhou (CN); Chao WU, Hangzhou (CN); Wenbin ZHAO, Moscow (RU)

(21) Appl. No.: 19/234,846

(22) Filed: Jun. 11, 2025

Related U.S. Application Data
(63) Continuation of application No. PCT/CN2023/119193, filed on Sep. 15, 2023.

(30) Foreign Application Priority Data
Dec. 16, 2022 (CN) 202211622597.4

(51) Int. Cl. H04R 3/04; H04R 5/033

(52) U.S. Cl. CPC H04R 3/04; H04R 5/033; H04R 2460/13

(57) ABSTRACT

This application discloses an audio signal restoration method and apparatus, a device, a storage medium, and a computer program, and pertains to the field of audio processing technologies. The method is applied to a headset, and the method includes determining a low-frequency feature of a bone conduction audio signal based on the bone conduction audio signal collected by a bone conduction microphone. The method also includes determining a restored low-frequency signal based on the low-frequency feature and a first air conduction audio signal collected by a first air conduction microphone, and determining an acoustic feature based on the restored low-frequency signal and the low-frequency feature. Furthermore, the method includes determining a target audio signal based on the restored low-frequency signal, a second air conduction audio signal collected by at least one second air conduction microphone, and the acoustic feature.

### CROSS-REFERENCE TO RELATED APPLICATIONS

This application is a continuation of International Application No. PCT/CN2023/119193, filed on Sep. 15, 2023, which claims priority to Chinese Patent Application No. 202211622597.4, filed on Dec. 16, 2022. The disclosures of the aforementioned applications are hereby incorporated by reference in their entireties.

### TECHNICAL FIELD

This application relates to the field of audio processing technologies, and in particular, to an audio signal restoration method and apparatus, a device, a storage medium, and a computer program.

### BACKGROUND

With popularization of true wireless stereo (TWS) headsets, more users use the headsets for calls, live broadcast, video recording, or the like. Therefore, quality of an audio signal collected by the headset becomes one of key factors that affect user experience. In a process of collecting the audio signal by the headset, due to a microphone, an environment in which the user is located, a wearing posture, or the like, energy of a medium- and high-frequency is weak or even missing. Consequently, quality of the audio signal is affected. Therefore, an audio signal restoration method is urgently needed to restore a damaged or missing medium- and high-frequency signal, to improve sound quality of the audio signal, and improve user experience of the headset.

### SUMMARY

This application provides an audio signal restoration method and apparatus, a device, a storage medium, and a computer program, so that quality and definition of a target audio signal can be improved. The technical solutions are as follows.

According to a first aspect, an audio signal restoration method is provided. The method is applied to a headset. The headset includes a bone conduction microphone, a first air conduction microphone, and at least one second air conduction microphone. The first air conduction microphone is configured to collect an air conduction signal inside an ear canal, and the at least one second air conduction microphone is configured to collect an air conduction signal in an external environment. In this method, a low-frequency feature of a bone conduction audio signal is determined based on the bone conduction audio signal collected by the bone conduction microphone. A restored low-frequency signal is determined based on the low-frequency feature and a first air conduction audio signal collected by the first air conduction microphone. An acoustic feature is determined based on the restored low-frequency signal and the low-frequency feature. A target audio signal is determined based on the restored low-frequency signal, a second air conduction audio signal collected by the at least one second air conduction microphone, and the acoustic feature, where the target audio signal includes a low-frequency signal and a medium- and high-frequency signal.

Because the bone conduction microphone collects the bone conduction audio signal through bone vibration, environmental noise can be shielded to some extent. Therefore, the low-frequency feature of the bone conduction audio signal can be more accurately extracted from the bone conduction audio signal. In addition, the first air conduction audio signal has a high signal-to-noise ratio. Therefore, restoration effect of the low-frequency signal can be improved based on the low-frequency feature and the first air conduction audio signal. In addition, the acoustic feature usually includes a feature of the audio signal in each frequency range, and the second air conduction audio signal collected by the at least one second air conduction microphone includes a medium- and high-frequency signal. Therefore, full-frequency signal restoration can be better guided in combination with the acoustic feature and the second air conduction audio signal collected by the at least one second air conduction microphone, to improve quality and definition of the target audio signal. In other words, the bone conduction audio signal collected by the bone conduction microphone, the first air conduction audio signal collected by the first air conduction microphone, and the second air conduction audio signal collected by the at least one second air conduction microphone are combined, so that quality and definition of the target audio signal can be improved.

Due to a propagation medium, a device, and the like, the bone conduction audio signal lacks a medium- and high-frequency signal. Therefore, to enable the bone conduction audio signal to be better fused with the second air conduction audio signal subsequently, harmonic generation is performed on the bone conduction audio signal according to a related algorithm by using a low-frequency signal in the bone conduction audio signal as a reference, so that the bone conduction audio signal includes both the low-frequency signal and the medium- and high-frequency signal.

There are a plurality of manners of determining the restored low-frequency signal based on the low-frequency feature and the first air conduction audio signal. The following separately describes two manners.

In a first manner, the low-frequency feature and the first air conduction audio signal are used as input of a low-frequency restoration network model, to obtain the restored low-frequency signal output by the low-frequency restoration network model.

Because the first air conduction microphone is blocked by the headset and an auricle, the first air conduction audio signal lacks a medium- and high-frequency signal. Therefore, to enable the first air conduction audio signal to be better fused with the second air conduction audio signal subsequently, in a process of determining the restored low-frequency signal by using the low-frequency restoration network model, harmonic generation is performed on the first air conduction audio signal according to a related algorithm by using a low-frequency signal in the first air conduction audio signal as a reference, so that the first air conduction audio signal includes both the low-frequency signal and the medium- and high-frequency signal.

In a second manner, the restored low-frequency signal is determined based on the low-frequency feature, the bone conduction audio signal, the first air conduction audio signal, and a second air conduction audio signal collected by a part or all of the at least one second air conduction microphone.

In other words, the bone conduction audio signal, the first air conduction audio signal, the second air conduction audio signals collected by the part or all of the at least one second air conduction microphone, and the low-frequency feature are combined to jointly determine the restored low-frequency signal, so that restoration effect of the low-frequency signal can be further improved.

In some embodiments, the bone conduction audio signal, the first air conduction audio signal, and the second air conduction audio signals collected by the part or all of the at least one second air conduction microphone are fused, to obtain a first fused signal. Then, the low-frequency feature and the first fused signal are used as input of a low-frequency restoration network model, to obtain the restored low-frequency signal output by the low-frequency restoration network model.

In some embodiments, before the restored low-frequency signal is determined based on the low-frequency feature, the bone conduction audio signal, the first air conduction audio signal, and the second air conduction audio signals collected by the part or all of the at least one second air conduction microphone, low-pass filtering may be further performed on the bone conduction audio signal, the first air conduction audio signal, and the second air conduction audio signals collected by the part or all of the at least one second air conduction microphone, so that restoration effect of the low-frequency signal can be further improved. In other words, the low-pass filtering method is used to separately block and weaken the medium- and high-frequency signals included in the bone conduction audio signal, the first air conduction audio signal, and the second air conduction audio signal collected by the part or all of the at least one second air conduction microphone, to obtain the low-frequency signal included in each of the plurality of signals. Then, the low-frequency signals included in the plurality of signals are fused to obtain the fused signal, so that the restored low-frequency signal is more accurately determined based on the low-frequency feature and the fused signal.

A first fusion coefficient and a second fusion coefficient are determined, where the first fusion coefficient is a fusion coefficient of the restored low-frequency signal, and the second fusion coefficient includes a fusion coefficient of the second air conduction audio signal collected by the at least one second air conduction microphone. The target audio signal is determined based on the restored low-frequency signal, the second air conduction audio signal collected by the at least one second air conduction microphone, the first fusion coefficient, the second fusion coefficient, and the acoustic feature.

There are a plurality of manners of determining the first fusion coefficient and the second fusion coefficient. The following separately describes three manners.

In a first manner, the first fusion coefficient is determined based on the acoustic feature. The second fusion coefficient is determined based on the second air conduction audio signal collected by the at least one second air conduction microphone.

In a second manner, a current target scenario is determined. The first fusion coefficient and the second fusion coefficient are determined based on the target scenario.

A computer device determines the current target scenario according to a related algorithm, and displays a first user interface, where the first user interface includes an identifier of the target scenario. When detecting a confirmation operation of a user, the computer device obtains, based on the identifier of the target scenario and from a stored correspondence between a scenario identifier and a fusion coefficient, the first fusion coefficient and the second fusion coefficient that correspond to the target scenario. When detecting a cancel operation of the user, the computer device displays a second user interface, where the second user interface includes a plurality of scenario identifiers. The user selects the identifier of the target scenario from the plurality of scenario identifiers. When detecting a confirmation operation of the user, the computer device uses a scenario identifier selected by the user as the identifier of the target scenario, and obtains, based on the identifier of the target scenario and from the stored correspondence between a scenario identifier and a fusion coefficient, the first fusion coefficient and the second fusion coefficient that correspond to the target scenario.

The foregoing content uses an example in which the computer device presets the correspondence between a scenario identifier and a fusion coefficient. Certainly, during actual application, the user can further adjust, in real time, the first fusion coefficient and the second fusion coefficient that are related to restoring the audio signal in the target scenario. For example, when detecting an adjustment operation of the user, the computer device displays a third user interface, where the third user interface includes an adjustment bar corresponding to the fusion coefficient. The user may adjust magnitudes of the first fusion coefficient and the second fusion coefficient by sliding the adjustment bar up or down. When detecting a confirmation operation of the user, the computer device determines, as the first fusion coefficient and the second fusion coefficient that correspond to the target scenario, the first fusion coefficient and the second fusion coefficient that are adjusted by the user.

It should be noted that, regardless of whether the user adjusts the fusion coefficient in real time for the target scenario, or the computer device presets the correspondence between a scenario identifier and a fusion coefficient, the first fusion coefficient and the second fusion coefficient are both set by the user in a personalized manner. That is, for a same target scenario, different users can adaptively adjust the fusion coefficient according to their own requirements, so that personalized and differentiated audio signal restoration is performed subsequently based on the fusion coefficient adjusted by the user. In addition, for different scenarios such as a conference room and outdoor sports, different fusion coefficients can be further set.

In a third manner, environmental detection is performed on a current target scenario to obtain an environmental detection result. The first fusion coefficient and the second fusion coefficient are determined based on the environmental detection result.

In the third manner, environmental detection is performed on the current target scenario, and the fusion coefficient is determined based on the environmental detection result, so that the target audio signal can be better applicable to a current environment.

In some embodiments, the restored low-frequency signal, the second air conduction audio signal collected by the at least one second air conduction microphone, the first fusion coefficient, the second fusion coefficient, and the acoustic feature are used as input of a full-frequency restoration network model, to obtain the target audio signal output by the full-frequency restoration network model.

It should be noted that, directly inputting, according to the foregoing operation, the restored low-frequency signal, the second air conduction audio signal collected by the at least one second air conduction microphone, the first fusion coefficient, the second fusion coefficient, and the acoustic feature to the full-frequency restoration network model to determine the target audio signal is merely an example. In some embodiments, the target audio signal can alternatively be determined in another manner. For example, the restored low-frequency signal and the second air conduction audio signal collected by the at least one second air conduction microphone are fused based on the first fusion coefficient and the second fusion coefficient, to obtain a second fused signal. Then, the second fused signal and the acoustic feature are used as input of a full-frequency restoration network model, to obtain the target audio signal output by the full-frequency restoration network model. In this way, a calculation amount of the full-frequency restoration network model can be reduced, to improve audio signal restoration efficiency.

According to a second aspect, an audio signal restoration apparatus is provided. The audio signal restoration apparatus has a function of implementing behavior of the audio signal restoration method according to the first aspect. The audio signal restoration apparatus includes at least one module. The at least one module is configured to implement the audio signal restoration method according to the first aspect.

According to a third aspect, a computer device is provided. The computer device includes a processor and a memory, and the memory is configured to store a computer program for performing the audio signal restoration method according to the first aspect. The processor is configured to execute the computer program stored in the memory, to implement the audio signal restoration method according to the first aspect.

In some embodiments, the computer device may further include a communication bus. The communication bus is configured to establish a connection between the processor and the memory.

According to a fourth aspect, a computer-readable storage medium is provided. The storage medium stores instructions. When the instructions are run on a computer, the computer is enabled to perform the operations of the audio signal restoration method according to the first aspect.

According to a fifth aspect, a computer program product including instructions is provided. When the instructions are run on a computer, the computer is enabled to perform the operations of the audio signal restoration method according to the first aspect. In other words, a computer program is provided. When the computer program is run on the computer, the computer is enabled to perform the operations of the audio signal restoration method according to the first aspect.

Technical effect obtained in the second aspect to the fifth aspect is similar to technical effect obtained by the corresponding technical means in the first aspect. Details are not described herein again.

### BRIEF DESCRIPTION OF DRAWINGS

FIG. 1 is a diagram of a structure of a headset according to an embodiment of this application;

FIG. 2 is a flowchart of an audio signal restoration method according to an embodiment of this application;

FIG. 3 is a diagram of training of a low-frequency restoration network model according to an embodiment of this application;

FIG. 4 is a diagram of a structure of a low-frequency restoration network model according to an embodiment of this application;

FIG. 5 is a diagram of training of another low-frequency restoration network model according to an embodiment of this application;

FIG. 6 is a diagram of obtaining a target audio signal by using a full-frequency restoration network model according to an embodiment of this application;

FIG. 7 is a diagram of an audio signal restoration procedure according to an embodiment of this application;

FIG. 8 is a diagram of a structure of an audio signal restoration apparatus according to an embodiment of this application; and

FIG. 9 is a diagram of a structure of a computer device according to an embodiment of this application.

### DESCRIPTION OF EMBODIMENTS

To make objectives, technical solutions, and advantages of embodiments of this application clearer, the following further describes implementations of this application in detail with reference to the accompanying drawings.

Before an audio signal restoration method provided in embodiments of this application is described in detail, terms and service scenarios in embodiments of this application are first described.

For case of understanding, the terms in embodiments of this application are first described.

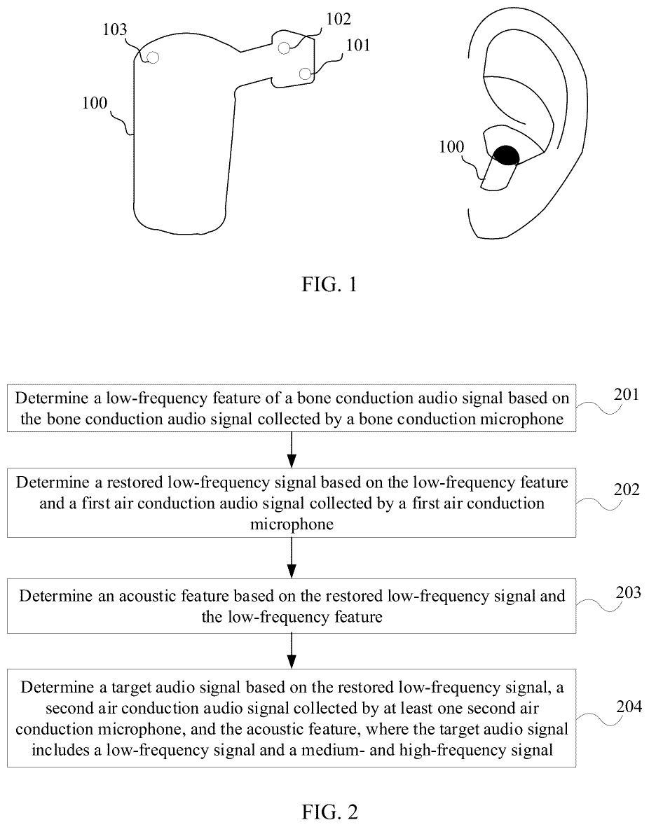

For example, FIG. 1 is a diagram of a structure of a headset according to an embodiment of this application. As shown in a left figure in FIG. 1, the headset 100 includes a bone conduction microphone 101, a first air conduction microphone 102, and at least one second air conduction microphone 103 (one second air conduction microphone is used as an example for description in FIG. 1).

Bone conduction microphone: The bone conduction microphone is configured to collect an audio signal propagated through a bone, where the audio signal may be referred to as a bone conduction audio signal. In other words, in a process of collecting the bone conduction audio signal by using the bone conduction microphone, audio sent by a sound source is transmitted to the bone conduction microphone through bone vibration. After receiving a vibration signal, the bone conduction microphone converts the vibration signal into an electrical signal, to collect the bone conduction audio signal.

Because the bone conduction microphone collects the bone conduction audio signal through bone vibration, environmental noise can be shielded to some extent. However, due to a propagation medium, a device, and the like, the bone conduction audio signal usually lacks a medium- and high-frequency signal Usually, a frequency range of the bone conduction audio signal is a first frequency range.

First air conduction microphone: The first air conduction microphone is a microphone configured to collect an audio signal propagated through air, and the audio signal may be referred to as a first air conduction audio signal. As shown in FIG. 1, the first air conduction microphone is deployed on an inner side of the headset. After the headset is worn on a human ear, the first air conduction microphone is located on the inner side of the human ear. Therefore, the first air conduction microphone may also be referred to as an in-ear air conduction microphone. A frequency range of the first air conduction audio signal is a second frequency range. In a process in which the first air conduction audio signal is collected by using the first air conduction microphone, because the first air conduction microphone is blocked by the headset and an auricle, environmental noise can be shielded to some extent, but the first air conduction audio signal lacks a medium- and high-frequency signal.

Second air conduction microphone: The second air conduction microphone is a microphone configured to collect an audio signal propagated through air, and the audio signal may be referred to as a second air conduction audio signal. As shown in FIG. 1, the second air conduction microphone is deployed on an outer side of the headset. After the headset is worn on the human ear, the second air conduction microphone is located on an outer side of the human ear. Therefore, the second air conduction microphone may also be referred to as an external-ear air conduction microphone. A frequency range of the second air conduction audio signal is a third frequency range. Usually, at least one second air conduction microphone is deployed on the outer side of the headset, and the second air conduction audio signal usually includes environmental noise.

It should be noted that the first frequency range is less than the second frequency range and the third frequency range. That is, the frequency range of the bone conduction audio signal is the lowest, the frequency range of the first air conduction audio signal is high, and the frequency range of the second air conduction audio signal is the highest. In addition, a sampling rate of the bone conduction microphone, a sampling rate of the first air conduction microphone, and a sampling rate of the second air conduction microphone are all the same.

Then, a service scenario in embodiments of this application is described.

The audio signal restoration method provided in embodiments of this application can be applied to a plurality of scenarios. For example, when an audio signal is low-pitched and unnatural, and lacks intelligibility and emotional expressiveness because the audio signal collected by a headset lacks a medium- and high-frequency signal, the audio signal collected by the headset is restored according to the method provided in embodiments of this application, to restore the medium- and high-frequency signal in the audio signal. A restored audio signal is closer to an audio signal sent by a sound source, so that quality, intelligibility, emotional expressiveness, and the like of the audio signal can be effectively improved. In this way, call experience of a user can be improved, and a word error rate and a character error rate of audio recognition in video recording can be reduced, and video editing efficiency of the user can be improved.

For another example, because a headset wearing posture of the user is incorrect, audio signals collected by one or more of a bone conduction microphone, a first air conduction microphone, and a second air conduction microphone that are deployed on the headset may be abnormal. In this case, the audio signal collected by the headset is restored according to the method provided in embodiments of this application, so that the abnormal signal can be improved.

The audio signal restoration method provided in embodiments of this application is executed by a computer device. The computer device includes a low-frequency feature extraction module, a low-frequency restoration module, an acoustic feature extraction module, a fusion coefficient obtaining module, and a full-frequency restoration module. The low-frequency feature extraction module is configured to perform feature extraction on a bone conduction audio signal according to an artificial intelligence (AI) algorithm, to obtain a low-frequency feature. The low-frequency restoration module is configured to determine a restored low-frequency signal based on the low-frequency feature and a first air conduction audio signal. The acoustic feature extraction module is configured to perform feature extraction according to the AI algorithm in combination with the restored low-frequency signal and the low-frequency feature, to obtain an acoustic feature. The fusion coefficient obtaining module is configured to determine a first fusion coefficient and a second fusion coefficient. The full-frequency restoration module is configured to fuse, based on the first fusion coefficient and the second fusion coefficient, the bone conduction audio signal, the first air conduction audio signal, and a second air conduction audio signal collected by at least one second air conduction microphone, a target audio signal that includes a low-frequency signal and a medium- and high-frequency signal.

The computer device may be any electronic product that may perform human-machine interaction with the user in one or more manners of a keyboard, a touchpad, a touchscreen, a remote control, a voice interaction device or a handwriting device, and the like. The computer device may be, for example, a personal computer (PC), a mobile phone, a smartphone, a personal digital assistant (PDA), a wearable device, a palmtop computer (PPC), a tablet computer, a smart screen, or a vehicle-mounted speaker.

A person skilled in the art should understand that the foregoing computer device is merely an example. Another existing or future computer device that may be applicable to embodiments of this application should also fall within the protection scope of embodiments of this application, and is included herein by reference.

It should be noted that service scenarios described in embodiments of this application are intended to describe technical solutions in embodiments of this application more clearly, and do not constitute a limitation on technical solutions provided in embodiments of this application. A person of ordinary skill in the art can know that technical solutions provided in embodiments of this application are also applicable to similar technical problems with emergence of new service scenarios.

FIG. 2 is a flowchart of an audio signal restoration method according to an embodiment of this application. Refer to FIG. 2. The method includes the following operations.

Operation 201: Determine a low-frequency feature of a bone conduction audio signal based on the bone conduction audio signal collected by a bone conduction microphone.

Based on the foregoing description, a computer device includes a low-frequency feature extraction module. The low-frequency feature extraction module performs feature extraction on the bone conduction audio signal according to an AI algorithm, to obtain the low-frequency feature. Certainly, during actual application, the low-frequency feature may alternatively be determined in another manner, for example, a cepstrum method or short-time Fourier transform (STFT). This is not limited in embodiments of this application.

The low-frequency feature means a fundamental frequency and a plurality of harmonic frequencies of the audio signal that are included in the audio signal.

Based on the foregoing description, due to a propagation medium, a device, and the like, the bone conduction audio signal lacks a medium- and high-frequency signal. Therefore, to enable the bone conduction audio signal to be better fused with a second air conduction audio signal subsequently, harmonic generation is performed on the bone conduction audio signal according to a related algorithm by using a low-frequency signal in the bone conduction audio signal as a reference, so that the bone conduction audio signal includes both the low-frequency signal and the medium- and high-frequency signal.

Operation 202: Determine a restored low-frequency signal based on the low-frequency feature and a first air conduction audio signal collected by a first air conduction microphone.

There are a plurality of manners of determining the restored low-frequency signal based on the low-frequency feature and the first air conduction audio signal. The following separately describes two manners.

In a first manner, the low-frequency feature and the first air conduction audio signal are used as input of a low-frequency restoration network model, to obtain the restored low-frequency signal output by the low-frequency restoration network model.

The low-frequency restoration network model is obtained by training a to-be-trained low-frequency restoration network model based on a first sample data set. The first sample data set includes a plurality of groups of sample data, and each of the plurality of groups of sample data includes a first sample air conduction audio signal, a sample low-frequency feature, and an actual sample low-frequency signal.

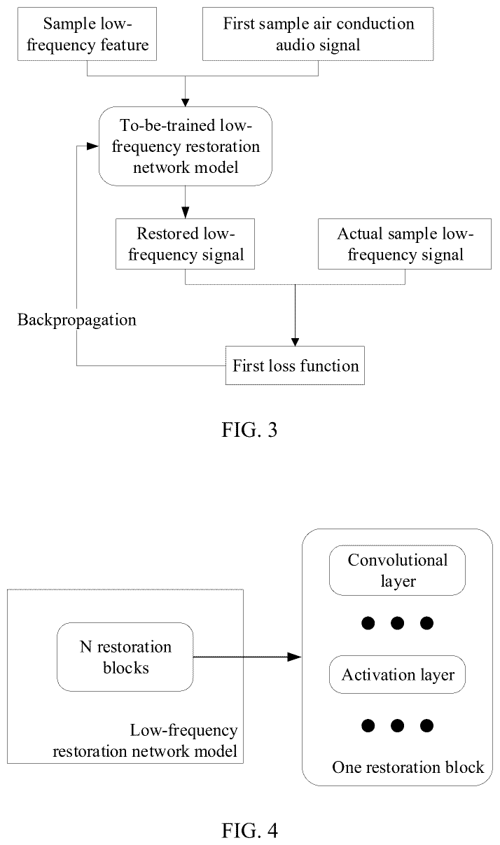

For example, FIG. 3 is a diagram of training of a low-frequency restoration network model according to an embodiment of this application. In FIG. 3, the sample low-frequency feature and the first sample air conduction audio signal are input to the to-be-trained low-frequency restoration network model, to obtain a restored low-frequency signal output by the to-be-trained low-frequency restoration network model. A first loss function is calculated based on the restored low-frequency signal and the actual sample low-frequency signal according to a related algorithm. Then, the low-frequency restoration network model is trained in a backpropagation manner according to the first loss function.

A loss function is also referred to as a cost function, and the loss function is an iterative basis of a network model in training. The loss function is used to evaluate a difference between an estimated value output by the network model and an actual value. Different network models use different loss functions. In this embodiment of this application, the loss function used by the low-frequency restoration network model is a mean square error (MSE) between an estimated value and an actual value. Certainly, the low-frequency restoration network model may alternatively use another loss function. This is not limited in embodiments of this application.

For example, a structure of the low-frequency restoration network model is a neural network structure. FIG. 4 is a diagram of a structure of a low-frequency restoration network model according to an embodiment of this application. In FIG. 4, the low-frequency restoration network model includes N restoration blocks, where N is an integer greater than or equal to 1, and each of the N restoration blocks includes at least one convolutional layer and at least one activation layer. It should be noted that the low-frequency restoration network model shown in FIG. 4 is merely an example. During actual application, the low-frequency restoration network model may alternatively be of another structure, the low-frequency restoration network model may further include another module, and each restoration block may alternatively include another functional layer. This is not limited in embodiments of this application.

Based on the foregoing description, because the first air conduction microphone is blocked by a headset and an auricle, the first air conduction audio signal lacks a medium- and high-frequency signal. Therefore, to enable the first air conduction audio signal to be better fused with the second air conduction audio signal subsequently, in a process of determining the restored low-frequency signal by using the low-frequency restoration network model, harmonic generation is performed on the first air conduction audio signal according to a related algorithm by using a low-frequency signal in the first air conduction audio signal as a reference, so that the first air conduction audio signal includes both the low-frequency signal and the medium- and high-frequency signal.

In a second manner, the restored low-frequency signal is determined based on the low-frequency feature, the bone conduction audio signal, the first air conduction audio signal, and a second air conduction audio signal collected by a part or all of at least one second air conduction microphone.

In other words, the bone conduction audio signal, the first air conduction audio signal, the second air conduction audio signals collected by the part or all of the at least one second air conduction microphone, and the low-frequency feature are combined to jointly determine the restored low-frequency signal, so that restoration effect of the low-frequency signal can be further improved.

In some embodiments, the bone conduction audio signal, the first air conduction audio signal, and the second air conduction audio signal collected by the part or all of the at least one second air conduction microphone are fused, to obtain a first fused signal. Then, the low-frequency feature and the first fused signal are used as input of a low-frequency restoration network model, to obtain the restored low-frequency signal output by the low-frequency restoration network model.

When the restored low-frequency signal is determined based on the low-frequency feature and the plurality of signals by using the low-frequency restoration network model, the low-frequency restoration network model is obtained by training a to-be-trained low-frequency restoration network model based on a second sample data set. The second sample data set includes a plurality of groups of sample data, and each of the plurality of groups of sample data includes a first sample fused signal, a sample low-frequency feature, and an actual sample low-frequency signal.

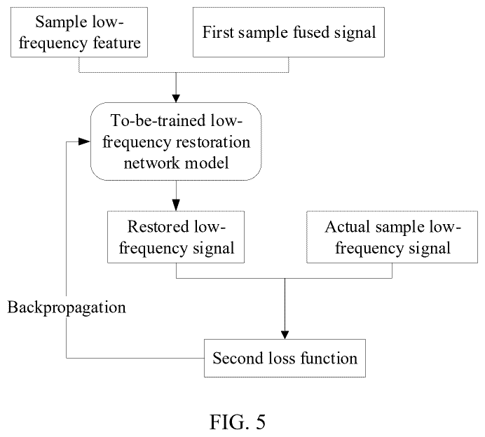

For example, FIG. 5 is a diagram of training of another low-frequency restoration network model according to an embodiment of this application. In FIG. 5, the sample low-frequency feature and the first sample fused signal are input to the to-be-trained low-frequency restoration network model, to obtain a restored low-frequency signal output by the to-be-trained low-frequency restoration network model. A second loss function is calculated based on the restored low-frequency signal and the actual sample low-frequency signal according to a related algorithm. Then, the low-frequency restoration network model is trained in a backpropagation manner according to the second loss function.

In some embodiments, before the restored low-frequency signal is determined based on the low-frequency feature, the bone conduction audio signal, the first air conduction audio signal, and the second air conduction audio signals collected by the part or all of the at least one second air conduction microphone, low-pass filtering may be further performed on the bone conduction audio signal, the first air conduction audio signal, and the second air conduction audio signals collected by the part or all of the at least one second air conduction microphone, so that restoration effect of the low-frequency signal can be further improved. In other words, the low-pass filtering method is used to separately block and weaken medium- and high-frequency signals included in the bone conduction audio signal, the first air conduction audio signal, and the second air conduction audio signal collected by the part or all of the at least one second air conduction microphone, to obtain a low-frequency signal included in each of the plurality of signals. Then, the low-frequency signals included in the plurality of signals are fused to obtain the fused signal, so that the restored low-frequency signal is more accurately determined based on the low-frequency feature and the fused signal.

Operation 203: An acoustic feature is determined based on the restored low-frequency signal and the low-frequency feature.

Based on the foregoing description, the computer device includes an acoustic feature extraction module. The acoustic feature extraction module performs feature extraction according to the AI algorithm in combination with the restored low-frequency signal and the low-frequency feature, to obtain the acoustic feature, where the acoustic feature includes a feature of the audio signal in each frequency range.

For example, the restored low-frequency signal and the low-frequency feature are used as input of the acoustic feature extraction module, to obtain a plurality of features such as a fundamental frequency, harmonics, pitch, and loudness that are output by the acoustic feature extraction module. Then, vectorized representation is performed on the plurality of features to obtain a target vector, where the target vector indicates the acoustic feature. The target vector includes a plurality of elements, and the plurality of elements are in a one-to-one correspondence with the plurality of features. Certainly, during actual application, the acoustic feature may alternatively be determined in another manner. This is not limited in embodiments of this application.

Operation 204: Determine a target audio signal based on the restored low-frequency signal, a second air conduction audio signal collected by the at least one second air conduction microphone, and the acoustic feature, where the target audio signal includes a low-frequency signal and a medium- and high-frequency signal.

A first fusion coefficient and a second fusion coefficient are determined, where the first fusion coefficient is a fusion coefficient of the restored low-frequency signal, and the second fusion coefficient includes a fusion coefficient of the second air conduction audio signal collected by the at least one second air conduction microphone. The target audio signal is determined based on the restored low-frequency signal, the second air conduction audio signal collected by the at least one second air conduction microphone, the first fusion coefficient, the second fusion coefficient, and the acoustic feature.

There are a plurality of manners of determining the first fusion coefficient and the second fusion coefficient. The following separately describes three manners.

In a first manner, the first fusion coefficient is determined based on the acoustic feature. The second fusion coefficient is determined based on the second air conduction audio signal collected by the at least one second air conduction microphone.

The computer device stores a correspondence between an acoustic feature and a fusion coefficient. Therefore, after the acoustic feature is determined according to operation 203, a fusion coefficient corresponding to the acoustic feature is obtained from the stored correspondence between an acoustic feature and a fusion coefficient based on the acoustic feature, to obtain the first fusion coefficient.

Based on the foregoing description, the at least one second air conduction microphone is usually deployed on an outer side of the headset, each of the at least one second air conduction microphone can collect a second air conduction audio signal, to obtain at least one second air conduction audio signal, and each of the at least one second air conduction audio signal corresponds to one second fusion coefficient. Because processes of determining second fusion coefficients corresponding to various second air conduction audio signals are the same, in the following, any one of the at least one second air conduction audio signal is selected as a target air conduction audio signal, to describe a process of determining a second fusion coefficient corresponding to the target air conduction audio signal. For a process of determining a second fusion coefficient of another air conduction audio signal in the at least one second air conduction audio signal, refer to the process of determining the second fusion coefficient corresponding to the target air conduction audio signal.

Pre-processing such as beamforming, gain control, and dual-microphone filtering is performed on the target air conduction audio signal, to obtain a plurality of features such as a signal-to-noise ratio and loudness, and then vectorized representation is performed on the plurality of features to obtain an eigenvector, where the eigenvector indicates a feature of the target air conduction audio signal. Then, a fusion coefficient corresponding to the eigenvector is obtained based on the eigenvector and from a stored correspondence between an eigenvector and a fusion coefficient, to obtain the second fusion coefficient of the target air conduction audio signal.

In a second manner, a current target scenario is determined. The first fusion coefficient and the second fusion coefficient are determined based on the target scenario.

The computer device determines the current target scenario according to a related algorithm, and displays a first user interface, where the first user interface includes an identifier of the target scenario. When detecting a confirmation operation of a user, the computer device obtains, based on the identifier of the target scenario and from a stored correspondence between a scenario identifier and a fusion coefficient, the first fusion coefficient and the second fusion coefficient that correspond to the target scenario. When detecting a cancel operation of the user, the computer device displays a second user interface, where the second user interface includes a plurality of scenario identifiers. The user selects the identifier of the target scenario from the plurality of scenario identifiers. When detecting a confirmation operation of the user, the computer device uses a scenario identifier selected by the user as the identifier of the target scenario, and obtains, based on the identifier of the target scenario and from the stored correspondence between a scenario identifier and a fusion coefficient, the first fusion coefficient and the second fusion coefficient that correspond to the target scenario.

In other words, for different target scenarios, the computer device pre-stores the correspondence between a scenario identifier and a fusion coefficient. When the target scenario determined by the computer device is the same as a scenario in which the user is actually located, the first fusion coefficient and the second fusion coefficient that correspond to the target scenario are obtained based on the identifier, of the target scenario, determined by the computer device and from the stored correspondence between a scenario identifier and a fusion coefficient. When the target scenario determined by the computer device is different from a scenario in which the user is actually located, the first fusion coefficient and the second fusion coefficient that correspond to the target scenario are obtained based on the identifier, of the target scenario, selected by the user and from the stored correspondence between a scenario identifier and a fusion coefficient.

The identifier of the target scenario uniquely identifies the target scenario. The identifier of the target scenario may be a number, a type, an area, or the like of the target scenario, or may be obtained by combining this information.

The confirmation operation of the user may be triggered through voice interaction, or may be triggered by a click operation on a submit button on the first user interface or the second user interface.

The foregoing content uses an example in which the computer device presets the correspondence between a scenario identifier and a fusion coefficient. Certainly, during actual application, the user can further adjust, in real time, the first fusion coefficient and the second fusion coefficient that are related to restoring the audio signal in the target scenario. For example, when detecting an adjustment operation of the user, the computer device displays a third user interface, where the third user interface includes an adjustment bar corresponding to the fusion coefficient. The user may adjust magnitudes of the first fusion coefficient and the second fusion coefficient by sliding the adjustment bar up or down. When detecting a confirmation operation of the user, the computer device determines, as the first fusion coefficient and the second fusion coefficient that correspond to the target scenario, the first fusion coefficient and the second fusion coefficient that are adjusted by the user.

The adjustment operation of the user is triggered through voice interaction, or is triggered by a click operation on an adjustment button. For example, the user triggers the adjustment operation by inputting a voice “adjust a fusion coefficient”.

It should be noted that, regardless of whether the user adjusts the fusion coefficient in real time for the target scenario, or the computer device presets the correspondence between a scenario identifier and a fusion coefficient, the first fusion coefficient and the second fusion coefficient are both set by the user in a personalized manner. That is, for a same target scenario, different users can adaptively adjust the fusion coefficient according to their own requirements, so that personalized and differentiated audio signal restoration is performed subsequently based on the fusion coefficient adjusted by the user. In addition, for different scenarios such as a conference room and outdoor sports, different fusion coefficients can be further set.

In a third manner, environmental detection is performed on a current target scenario to obtain an environmental detection result. The first fusion coefficient and the second fusion coefficient are determined based on the environmental detection result.

The computer device performs, according to a related algorithm, environmental detection on the current target scenario, to obtain the environmental detection result. Because the computer device stores a correspondence between an environmental detection result and a fusion coefficient, a fusion coefficient corresponding to the environmental detection result is obtained based on the environmental detection result and from the stored correspondence between an environmental detection result and a fusion coefficient, to obtain the first fusion coefficient and the second fusion coefficient.

The environmental detection result includes a signal-to-noise ratio detection result and a wind noise detection result. Certainly, during actual application, the environmental detection result may further include other information. This is not limited in embodiments of this application.

In the third manner, environmental detection is performed on the current target scenario, and the fusion coefficient is determined based on the environmental detection result, so that the target audio signal can be better applicable to a current environment.

In some embodiments, the restored low-frequency signal, the second air conduction audio signal collected by the at least one second air conduction microphone, the first fusion coefficient, the second fusion coefficient, and the acoustic feature are used as input of a full-frequency restoration network model, to obtain the target audio signal output by the full-frequency restoration network model.

The full-frequency restoration network model is obtained by training a to-be-trained full-frequency restoration network model based on a third sample data set. The third sample data set includes a plurality of groups of sample data, and each of the plurality of groups of sample data includes a sample restored low-frequency signal, a second sample air conduction audio signal, a first sample fusion coefficient, a second sample fusion coefficient, a sample acoustic feature, and an actual sample audio signal.

A training process of the full-frequency restoration network model is similar to the training process of the low-frequency restoration network model in operation 202. Therefore, refer to related content in operation 202, and details are not described herein again.

A structure of the full-frequency restoration network model is a convolution recurrent neural network (CRNN) structure, and the full-frequency restoration network model includes an encoding part and a decoding part. The encoding part includes at least one encoding layer, and the decoding part includes at least one decoding layer.

In the following, for example, the encoding part includes a first encoding layer, a second encoding layer, and a third encoding layer, and the decoding part includes a first decoding layer, a second decoding layer, and a third decoding layer. In this case, an implementation process of using the restored low-frequency signal, the second air conduction audio signal collected by the at least one second air conduction microphone, the first fusion coefficient, the second fusion coefficient, and the acoustic feature as the input of the full-frequency restoration network model, to obtain the target audio signal output by the full-frequency restoration network model includes the following operations (1) to (6):
(1) Input the restored low-frequency signal, the second air conduction audio signal collected by the at least one second air conduction microphone, the first fusion coefficient, the second fusion coefficient, and the acoustic feature to the first encoding layer, to obtain a first encoding result output by the first encoding layer.
(2) Input the first encoding result to the second encoding layer, to obtain a second encoding result output by the second encoding layer.
(3) Input the second encoding result to the third encoding layer, to obtain a third encoding result output by the third encoding layer.
(4) Input the third encoding result output by the third encoding layer and the second encoding result output by the second encoding layer to the first decoding layer, to obtain a first decoding result output by the first decoding layer.
(5) Input the first decoding result output by the first decoding layer and the first encoding result output by the first encoding layer to the second decoding layer, to obtain a second decoding result output by the second decoding layer.
(6) Input the second decoding result output by the second decoding layer, the restored low-frequency signal, the second air conduction audio signal collected by the at least one second air conduction microphone, the first fusion coefficient, the second fusion coefficient, and the acoustic feature are input to the third decoding layer, to obtain a third decoding result output by the third decoding layer, and then determine the third decoding result as the target audio signal.

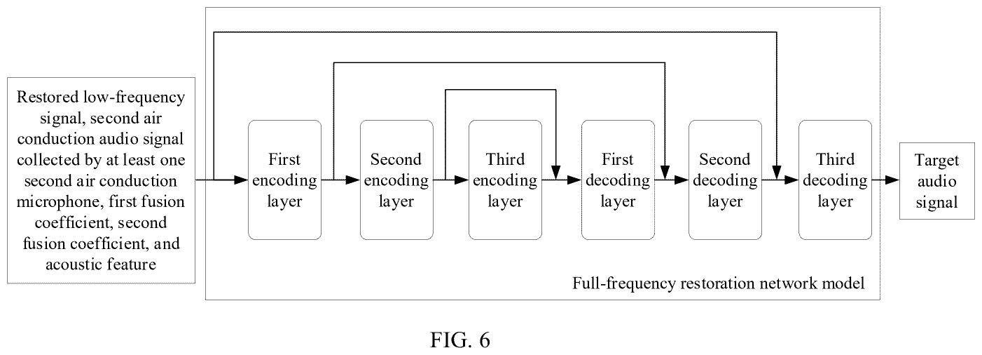

For example, FIG. 6 is a diagram of obtaining a target audio signal by using a full-frequency restoration network model according to an embodiment of this application. In FIG. 6, a restored low-frequency signal, a second air conduction audio signal collected by at least one second air conduction microphone, a first fusion coefficient, a second fusion coefficient, and an acoustic feature are input to the full-frequency restoration network model, to determine the target audio signal by using three encoding layers and three decoding layers included in the full-frequency restoration network model.

It should be noted that, directly inputting, according to the foregoing operation, the restored low-frequency signal, the second air conduction audio signal collected by the at least one second air conduction microphone, the first fusion coefficient, the second fusion coefficient, and the acoustic feature to the full-frequency restoration network model to determine the target audio signal is merely an example. In some other embodiments, the target audio signal can alternatively be determined in another manner. For example, the restored low-frequency signal and the second air conduction audio signal collected by the at least one second air conduction microphone are fused based on the first fusion coefficient and the second fusion coefficient, to obtain a second fused signal. Then, the second fused signal and the acoustic feature are used as input of the full-frequency restoration network model, to obtain the target audio signal output by the full-frequency restoration network model. In this way, a calculation amount of the full-frequency restoration network model can be reduced, to improve audio signal restoration efficiency.

The restored low-frequency signal includes signal frequencies at a plurality of moments, and the second air conduction audio signal collected by the at least one second air conduction microphone also includes signal frequencies at a plurality of moments. An implementation process of fusing, based on the first fusion coefficient and the second fusion coefficient, the restored low-frequency signal and the second air conduction audio signal collected by the at least one second air conduction microphone, to obtain the fused signal includes: separately obtaining the restored low-frequency signal and a signal frequency at a same moment in the second air conduction audio signal collected by the at least one second air conduction microphone, to obtain a first frequency and at least one second frequency. The first frequency is multiplied by the first fusion coefficient, to obtain a first reference frequency. The at least one second frequency is separately multiplied by the second fusion coefficient corresponding to the at least one second air conduction audio signal, to obtain at least one second reference frequency. Then, the first reference frequency and the at least one second reference frequency are added, to obtain a target frequency, and the target frequency is used as a signal frequency at that moment in the fused signal. In this way, all of the plurality of moments are sequentially traversed, to obtain a plurality of target frequencies, and the plurality of target frequencies are in a one-to-one correspondence with the plurality of moments. The plurality of target frequencies are arranged and combined in a time sequence, to obtain the fused signal.

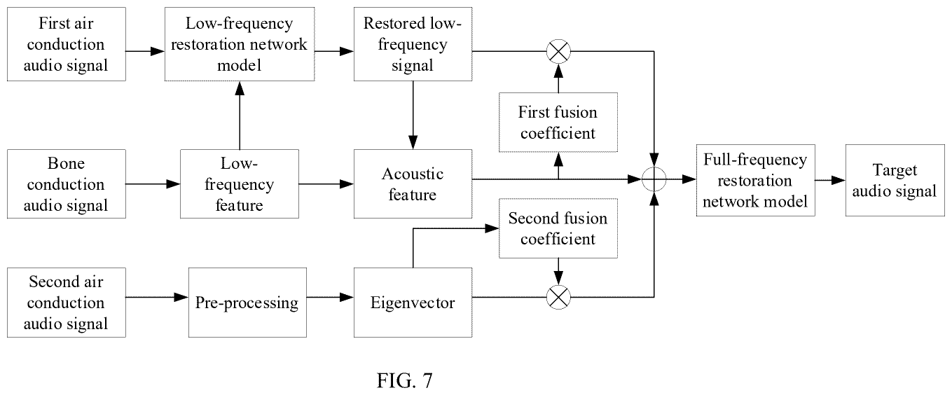

The following uses FIG. 7 as an example to comprehensively describe an audio signal restoration procedure provided in embodiments of this application. In FIG. 7, for example, a second air conduction microphone is deployed on an outer side of a headset, an air conduction audio signal collected by a first air conduction microphone is referred to as a first air conduction audio signal, and an air conduction audio signal collected by a second air conduction microphone is referred to as a second air conduction audio signal. A low-frequency feature is determined based on a bone conduction audio signal, and the low-frequency feature and the first air conduction audio signal are input to a low-frequency restoration network model, to obtain a restored low-frequency signal output by the low-frequency restoration network model. Then, an acoustic feature is determined based on the restored low-frequency signal and the low-frequency feature, and a first fusion coefficient is determined based on the acoustic feature. In addition, pre-processing is performed on the second air conduction audio signal, to obtain an eigenvector, and a second fusion coefficient is determined based on the eigenvector. Finally, the restored low-frequency signal, the second air conduction audio signal, the first fusion coefficient, the second fusion coefficient, and the acoustic feature are input to a full-frequency restoration network model, to obtain a target audio signal output by the full-frequency restoration network model.

In embodiments of this application, because the bone conduction microphone collects the bone conduction audio signal through bone vibration, environmental noise can be shielded to some extent. Therefore, the low-frequency feature of the bone conduction audio signal can be more accurately extracted from the bone conduction audio signal. In addition, the first air conduction audio signal has a high signal-to-noise ratio. Therefore, restoration effect of the low-frequency signal can be improved based on the low-frequency feature and the first air conduction audio signal. In addition, the acoustic feature usually includes the feature of the audio signal in each frequency range, and the second air conduction audio signal collected by the at least one second air conduction microphone includes the medium- and high-frequency signal. Therefore, full-frequency signal restoration can be better guided in combination with the acoustic feature and the second air conduction audio signal collected by the at least one second air conduction microphone, to improve quality and definition of the target audio signal. In other words, the bone conduction audio signal collected by the bone conduction microphone, the first air conduction audio signal collected by the first air conduction microphone, and the second air conduction audio signal collected by the at least one second air conduction microphone are combined, so that quality and definition of the target audio signal can be improved. In addition, personalized and differentiated audio signal restoration can be implemented in combination with the current scenario and the fusion coefficient adaptively adjusted by the user according to the requirement of the user. Alternatively, environmental detection is performed on the current target scenario, and the fusion coefficient is determined based on the environmental detection result, so that the target audio signal can be better applicable to the current environment.

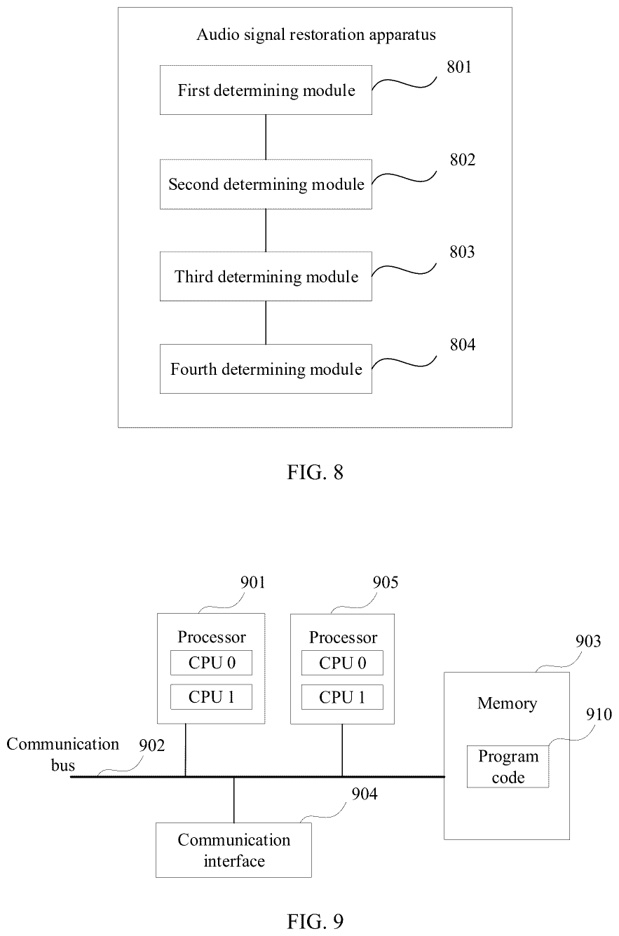

FIG. 8 is a diagram of a structure of an audio signal restoration apparatus according to an embodiment of this application. The audio signal restoration apparatus may be implemented as a part or all of a computer device by using software, hardware, or a combination thereof. As shown in FIG. 8, the apparatus includes a first determining module 801, a second determining module 802, a third determining module 803, and a fourth determining module 804.

The first determining module 801 is configured to determine a low-frequency feature of a bone conduction audio signal based on the bone conduction audio signal collected by a bone conduction microphone. For a detailed implementation process, refer to corresponding content in the foregoing embodiments. Details are not described herein again.

The second determining module 802 is configured to determine a restored low-frequency signal based on the low-frequency feature and a first air conduction audio signal collected by a first air conduction microphone. For a detailed implementation process, refer to corresponding content in the foregoing embodiments. Details are not described herein again.

The third determining module 803 is configured to determine an acoustic feature based on the restored low-frequency signal and the low-frequency feature. For a detailed implementation process, refer to corresponding content in the foregoing embodiments. Details are not described herein again.

The fourth determining module 804 is configured to determine a target audio signal based on the restored low-frequency signal, a second air conduction audio signal collected by at least one second air conduction microphone, and the acoustic feature, where the target audio signal includes a low-frequency signal and a medium- and high-frequency signal. For a detailed implementation process, refer to corresponding content in the foregoing embodiments. Details are not described herein again.

In some embodiments, the second determining module 802 is specifically configured to:
use the low-frequency feature and the first air conduction audio signal as input of a low-frequency restoration network model, to obtain the restored low-frequency signal output by the low-frequency restoration network model.

In some embodiments, the second determining module 802 includes:
a determining unit, configured to determine the restored low-frequency signal based on the low-frequency feature, the bone conduction audio signal, the first air conduction audio signal, and a second air conduction audio signal collected by a part or all of the at least one second air conduction microphone.

In some embodiments, the determining unit is specifically configured to:
fuse the bone conduction audio signal, the first air conduction audio signal, and the second air conduction audio signal collected by the part or all of the at least one second air conduction microphone, to obtain a first fused signal; and
use the low-frequency feature and the first fused signal as input of a low-frequency restoration network model, to obtain the restored low-frequency signal output by the low-frequency restoration network model.

In some embodiments, the fourth determining module 804 includes:
a first determining unit, configured to determine a first fusion coefficient and a second fusion coefficient, where the first fusion coefficient is a fusion coefficient of the restored low-frequency signal, and the second fusion coefficient includes a fusion coefficient of the second air conduction audio signal collected by the at least one second air conduction microphone; and
a second determining unit, configured to determine the target audio signal based on the restored low-frequency signal, the second air conduction audio signal collected by the at least one second air conduction microphone, the first fusion coefficient, the second fusion coefficient, and the acoustic feature.

In some embodiments, the second determining unit is specifically configured to:
use the restored low-frequency signal, the second air conduction audio signal collected by the at least one second air conduction microphone, the first fusion coefficient, the second fusion coefficient, and the acoustic feature as input of a full-frequency restoration network model, to obtain the target audio signal output by the full-frequency restoration network model.

In some embodiments, the second determining unit is specifically configured to:
fuse, based on the first fusion coefficient and the second fusion coefficient, the restored low-frequency signal and the second air conduction audio signal collected by the at least one second air conduction microphone, to obtain a second fused signal; and
use the second fused signal and the acoustic feature as input of a full-frequency restoration network model, to obtain the target audio signal output by the full-frequency restoration network model.

In some embodiments, the first determining unit is specifically configured to:
determine the first fusion coefficient based on the acoustic feature, and determine the second fusion coefficient based on the second air conduction audio signal collected by the at least one second air conduction microphone;
determine a current target scenario, and determine the first fusion coefficient and the second fusion coefficient based on the target scenario; or
perform environmental detection on a current target scenario to obtain an environmental detection result, and determine the first fusion coefficient and the second fusion coefficient based on the environmental detection result.

In embodiments of this application, because the bone conduction microphone collects the bone conduction audio signal through bone vibration, environmental noise can be shielded to some extent. Therefore, the low-frequency feature of the bone conduction audio signal can be more accurately extracted from the bone conduction audio signal. In addition, the first air conduction audio signal has a high signal-to-noise ratio. Therefore, restoration effect of the low-frequency signal can be improved based on the low-frequency feature and the first air conduction audio signal. In addition, the acoustic feature usually includes the feature of the audio signal in each frequency range, and the second air conduction audio signal collected by the at least one second air conduction microphone includes the medium- and high-frequency signal. Therefore, full-frequency signal restoration can be better guided in combination with the acoustic feature and the second air conduction audio signal collected by the at least one second air conduction microphone, to improve quality and definition of the target audio signal. In other words, the bone conduction audio signal collected by the bone conduction microphone, the first air conduction audio signal collected by the first air conduction microphone, and the second air conduction audio signal collected by the at least one second air conduction microphone are combined, so that quality and definition of the target audio signal can be improved. In addition, personalized and differentiated audio signal restoration can be implemented in combination with the current scenario and the fusion coefficient adaptively adjusted by the user according to the requirement of the user. Alternatively, environmental detection is performed on the current target scenario, and the fusion coefficient is determined based on the environmental detection result, so that the target audio signal can be better applicable to the current environment.

It should be noted that when the audio signal restoration apparatus provided in the foregoing embodiment performs audio signal restoration, division of the foregoing functional modules is merely used as an example for description. During actual application, the foregoing functions may be allocated to different functional modules for implementation according to a requirement. In other words, an internal structure of the apparatus is divided into different functional modules to implement all or some of the functions described above. In addition, the audio signal restoration apparatus provided in the foregoing embodiment and the audio signal restoration method embodiments pertain to a same concept. For a specific implementation process thereof, refer to the method embodiments. Details are not described herein again.

FIG. 9 is a diagram of a structure of a computer device according to an embodiment of this application. The computer device includes at least one processor 901, a communication bus 902, a memory 903, and at least one communication interface 904.

The processor 901 may be a general-purpose central processing unit (CPU), a network processor (NP), or a microprocessor, or may be one or more integrated circuits configured to implement the solutions of this application, for example, an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

The communication bus 902 is configured to transfer information between the foregoing components. The communication bus 902 may be classified as an address bus, a data bus, a control bus, or the like. For ease of representation, only one thick line is for representing the bus in the figure, but this does not mean that there is only one bus or only one type of bus.

The memory 903 may be a read-only memory (ROM), a random access memory (RAM), an electrically erasable programmable read-only memory (EEPROM), an optical disc (including a compact disc read-only memory (CD-ROM), a compact disc, a laser disc, a digital versatile disc, a Blu-ray disc, or the like), a magnetic disk storage medium or another magnetic storage device, or any other medium that can be configured to carry or store expected program code in a form of instructions or data structure and that can be accessed by a computer, but is not limited thereto. The memory 903 may exist independently, and is connected to the processor 901 through the communication bus 902. Alternatively, the memory 903 and the processor 901 may be integrated together.

The communication interface 904 uses any apparatus such as a transceiver, and is configured to communicate with another device or a communication network. The communication interface 904 includes a wired communication interface, and may include a wireless communication interface. The wired communication interface may be, for example, an Ethernet interface. The Ethernet interface may be an optical interface, an electrical interface, or a combination thereof. The wireless communication interface may be a wireless local area network (WLAN) interface, a cellular network communication interface, a combination thereof, or the like.

During specific implementation, in an embodiment, the processor 901 may include one or more CPUs, for example, a CPU 0 and a CPU 1 in FIG. 9.

During specific implementation, in an embodiment, the computer device includes a plurality of processors, for example, the processor 901 and a processor 905 shown in FIG. 9. Each of the processors may be a single-core processor, or may be a multi-core processor. The processor herein may be one or more devices, circuits, and/or processing cores configured to process data (for example, computer program instructions).

During specific implementation, in an embodiment, the computer device may further include an output device 906 and an input device 907. The output device 906 communicates with the processor 901, and may display information in a plurality of manners. For example, the output device 906 may be a liquid crystal display (LCD), a light-emitting diode (LED) display device, a cathode ray tube (CRT) display device, a projector (projector), or the like. The input device 907 communicates with the processor 901, and may receive a user input in a plurality of manners. For example, the input device 907 may be a mouse, a keyboard, a touchscreen device, a sensing device, or the like.

In some embodiments, the memory 903 is configured to store program code 910 for executing the solutions of this application, and the processor 901 may execute the program code 910 stored in the memory 903. The program code 910 may include one or more software modules. The computer device may implement, by using the processor 901 and the program code 910 in the memory 903, the audio signal restoration method provided in the embodiment in FIG. 2.

All or some of the foregoing embodiments may be implemented by software, hardware, firmware, or any combination thereof. When software is used to implement the embodiments, all or a part of the embodiments may be implemented in a form of computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid-state disk (SSD)), or the like. It should be noted that the computer-readable storage medium in embodiments of this application may be a non-volatile storage medium, that is, may be a non-transitory storage medium.

In other words, an embodiment of this application further provides a computer-readable storage medium. The computer-readable storage medium stores instructions. When the instructions are run on a computer, the computer is enabled to perform the operations of the foregoing audio signal restoration method.

An embodiment of this application further provides a computer program product including instructions. When the instructions are run on a computer, the computer is enabled to perform the operations of the foregoing audio signal restoration method. Alternatively, a computer program is provided. When the computer program is run on a computer, the computer is enabled to perform the operations of the foregoing audio signal restoration method.

It should be understood that “a plurality of” in this specification means two or more. In descriptions of embodiments of this application, “/” means “or” unless otherwise specified. For example, A/B may indicate A or B. In this specification, “and/or” merely describes an association relationship between associated objects and indicates that three relationships may exist. For example, A and/or B may indicate the following three cases: Only A exists, both A and B exist, and only B exists. In addition, to clearly describe technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of this application are used under authorization by the user or full authorization by all parties, and capturing, use, and processing of related data need to conform to related laws, regulations, and standards of related countries and regions. For example, in embodiments of this application, the bone conduction audio signal collected by the bone conduction microphone, the first air conduction audio signal collected by the first air conduction microphone, and the second air conduction audio signal collected by the at least one second air conduction microphone are all obtained under sufficient authorization.

The foregoing descriptions are merely embodiments of this application, but are not intended to limit this application. Any modification, equivalent replacement, or improvement made without departing from the spirit and principle of this application should fall within the protection scope of this application.

What is claimed is:

1. An audio signal restoration method, comprising:
determining a first part of audio signals based on a bone conduction audio signal collected by a bone conduction microphone comprised in a headset and a first air conduction audio signal collected by a first air conduction microphone comprised in the headset, wherein the headset further comprises at least one second air conduction microphone, and wherein the first air conduction microphone is configured to collect an air conduction signal inside an ear canal, and the at least one second air conduction microphone is configured to collect an air conduction signal in an external environment; and
determining a restored audio signal based on the first part of audio signals and a second air conduction audio signal collected by the at least one second air conduction microphone, wherein the restored audio signal comprises a medium-frequency and high-frequency signal and energy of the medium-frequency and high-frequency signal comprised is not lower than energy of a medium-frequency and high-frequency signal collected by the microphone in the headset.

2. The method according to claim 1, wherein the first part of audio signals are used to restore a low-frequency signal collected by the microphone in the headset, and the restored audio signal further comprises a restored low-frequency signal.

3. The method according to claim 1, wherein determining the restored audio signal based on the first part of audio signals and the second air conduction audio signal collected by the at least one second air conduction microphone comprises:
determining a signal fusion coefficient; and
determining the restored audio signal based on the first part of audio signals, the second air conduction audio signal collected by the at least one second air conduction microphone, and the signal fusion coefficient.

4. The method according to claim 3, wherein the signal fusion coefficient comprises a first fusion coefficient and/or a second fusion coefficient, the first fusion coefficient is a fusion coefficient of the first part of audio signals, and the second fusion coefficient comprises a fusion coefficient of the second air conduction audio signal collected by the at least one second air conduction microphone.

5. The method according to claim 3, wherein determining the restored audio signal based on the first part of audio signals, the second air conduction audio signal collected by the at least one second air conduction microphone, and the signal fusion coefficient comprises:
determining, by using a full-frequency restoration network model, the restored audio signal based on the first part of audio signals, the second air conduction audio signal collected by the at least one second air conduction microphone, and the signal fusion coefficient.

6. The method according to claim 3, wherein the signal fusion coefficient is a user-adjustable coefficient.

7. The method according to claim 3, wherein determining the signal fusion coefficient comprises:
determining a current scenario, and determining the signal fusion coefficient based on the current scenario; or
performing environmental detection on a current scenario to obtain an environmental detection result, and determining the signal fusion coefficient based on the environmental detection result.

8. The method according to claim 7, wherein determining the current scenario, and determining the signal fusion coefficient based on the current scenario comprises:
displaying a first user interface, wherein the first user interface comprises an identifier of the current scenario; and
when a confirmation operation of a user on the identifier, of the current scenario, displayed on the first user interface is detected, obtaining, based on the identifier of the current scenario, the signal fusion coefficient corresponding to the current scenario.

9. The method according to claim 7, wherein determining the current scenario, and determining the signal fusion coefficient based on the current scenario comprises:
displaying a second user interface, wherein the second user interface comprises a plurality of scenario identifiers, and the second user interface indicates the user to select a scenario identifier from the plurality of scenario identifiers;
when a confirmation operation of the user on the selected scenario identifier is detected, determining the scenario identifier selected by the user as an identifier of the current scenario; and
obtaining, based on the identifier of the current scenario, the signal fusion coefficient corresponding to the current scenario.

10. The method according to claim 3, wherein determining the signal fusion coefficient comprises:
displaying a third user interface, wherein the third user interface comprises an adjustment bar corresponding to the fusion coefficient; and
when a confirmation operation of a user after adjustment of the adjustment bar is detected, determining an adjusted fusion coefficient as the signal fusion coefficient.

11. The method according to claim 1, wherein the restored audio signal is used as a call voice signal, a recording signal, or a live voice signal, the call voice signal is used for transmission to a call peer end, and the live voice signal is used for transmission to a live listening end.

12. A computer device, comprising:
a memory configured to store a computer program; and
a processor, coupled with the memory, configured to execute the computer program stored in the memory, to implement operations of an audio signal restoration method, applied to a headset, wherein the headset comprises a bone conduction microphone, a first air conduction microphone, and at least one second air conduction microphone, the first air conduction microphone is configured to collect an air conduction signal inside an ear canal, and the at least one second air conduction microphone is configured to collect an air conduction signal in an external environment, and the operations comprise:
determining a first part of audio signals based on a bone conduction audio signal collected by the bone conduction microphone and a first air conduction audio signal collected by the first air conduction microphone, and
determining a restored audio signal based on the first part of audio signals and a second air conduction audio signal collected by the at least one second air conduction microphone, wherein the restored audio signal comprises a medium-frequency and high-frequency signal and energy of the medium-frequency and high-frequency signal comprised is not lower than energy of a medium-frequency and high-frequency signal collected by the microphone in the headset.

13. The computer device according to claim 12, wherein the first part of audio signals are used to restore a low-frequency signal collected by the microphone in the headset, and the restored audio signal further comprises a restored low-frequency signal.

14. The computer device according to claim 12, wherein determining the restored audio signal based on the first part of audio signals and the second air conduction audio signal collected by the at least one second air conduction microphone comprises:
determining a signal fusion coefficient; and
determining the restored audio signal based on the first part of audio signals, the second air conduction audio signal collected by the at least one second air conduction microphone, and the signal fusion coefficient.

15. The computer device according to claim 14, wherein the signal fusion coefficient comprises a first fusion coefficient and/or a second fusion coefficient, the first fusion coefficient is a fusion coefficient of the first part of audio signals, and the second fusion coefficient comprises a fusion coefficient of the second air conduction audio signal collected by the at least one second air conduction microphone.

16. The computer device according to claim 14, wherein determining the restored audio signal based on the first part of audio signals, the second air conduction audio signal collected by the at least one second air conduction microphone, and the signal fusion coefficient comprises: determining, by using a full-frequency restoration network model, the restored audio signal based on the first part of audio signals, the second air conduction audio signal collected by the at least one second air conduction microphone, and the signal fusion coefficient.

17. The computer device according to claim 14, wherein the signal fusion coefficient is a user-adjustable coefficient.

18. The computer device according to claim 14, wherein determining the signal fusion coefficient comprises:
determining a current scenario, and determining the signal fusion coefficient based on the current scenario; or
performing environmental detection on a current scenario to obtain an environmental detection result, and determining the signal fusion coefficient based on the environmental detection result.

19. The computer device according to claim 18, wherein determining the current scenario, and determining the signal fusion coefficient based on the current scenario comprises: displaying a first user interface, wherein the first user interface comprises an identifier of the current scenario; and
when a confirmation operation of a user on the identifier, of the current scenario, displayed on the first user interface is detected, obtaining, based on the identifier of the current scenario, the signal fusion coefficient corresponding to the current scenario.

20. A non-transitory computer-readable storage medium, wherein the storage medium stores instructions, and when the instructions are run on a computer, the computer is enabled to perform operations of an audio signal restoration method, comprising:
determining a first part of audio signals based on a bone conduction audio signal collected by a bone conduction microphone comprised in a headset and a first air conduction audio signal collected by a first air conduction microphone comprised in the headset, wherein the headset further comprises at least one second air conduction microphone, and wherein the first air conduction microphone is configured to collect an air conduction signal inside an ear canal, and the at least one second air conduction microphone is configured to collect an air conduction signal in an external environment; and
determining a restored audio signal based on the first part of audio signals and a second air conduction audio signal collected by the at least one second air conduction microphone, wherein the restored audio signal comprises a medium-frequency and high-frequency signal and energy of the medium-frequency and high-frequency signal comprised is not lower than energy of a medium-frequency and high-frequency signal collected by the microphone in the headset.
